(19) United States
(12) Patent Application Publication
(10) Pub. No.: US 2026/0178516 A1
(43) Pub. Date: Jun. 25, 2026

(54) INFORMATION PROCESSING SYSTEM, PERIPHERAL DEVICE, AND INFORMATION PROCESSING METHOD

(71) Applicant: STAR MICRONICS CO., LTD., SHIZUOKA (JP)

(72) Inventors: TEPPEI ONO, SHIZUOKA (JP); KEISUKE IGARASHI, SHIZUOKA (JP); YUSUKE HARA, SHIZUOKA (JP)

(21) Appl. No.: 19/427,571

(22) Filed: Dec. 19, 2025

(30) Foreign Application Priority Data
Dec. 25, 2024 (JP) 2024-229530

(51) Int. Cl. G06F 13/12

(52) U.S. Cl. CPC G06F 13/122

(57) ABSTRACT

An information processing system is configured such that a printer is connected through USB to a host device that executes a web application, and a BCR is also connected to the printer through USB. The information processing system is configured to: perform serial communication between the host device and the printer via a virtual serial port; and using, as a trigger, when the printer receives, from the BCR, acquisition data acquired by the BCR; and transmit the peripheral device acquisition data from the printer to the host device via the virtual serial port. This enables the printer to actively transmit the peripheral device acquisition data to the host device with no time lag at the time when the printer receives the peripheral device acquisition data from the BCR.

### CROSS-REFERENCES

The application claims priority of Japanese Patent Application No. 2024-229530 filed on Dec. 25, 2024. The contents of this application are incorporated herein by reference in their entirety.

### BACKGROUND OF THE INVENTION

### 1. Field of the Invention

The present invention relates to an information processing system, a peripheral device, and an information processing method, and more particularly to, those suitable for use in a system having a network configuration in which a first peripheral device is connected to a host device and a second peripheral device is connected to the first peripheral device.

### 2. Description of the Related Art

A conventional system has been known that is configured such that, in a network configuration in which a printer is connected to a host device and another peripheral device is connected to the printer, the host device acquires acquisition data acquired by the peripheral device via the printer (e.g., see Japanese Patent Application Publication No. 2018-032298).

In the system described in Japanese Patent Application Publication No. 2018-032298, the printer periodically transmits a status acquisition request inquiring about the status of the peripheral device, and acquires and stores status data of the peripheral device in response to the request. Then, when the printer receives the status acquisition request from a web print server of the host device, the printer responds to the web print server with the status data of the peripheral device together with the printer's own status data.

In the technology described in Japanese Patent Application Publication No. 2018-032298, the host device (web print server) repeatedly polls the printer at regular time intervals, and the printer repeatedly polls the peripheral device at regular time intervals. Since there is a waiting time until the next polling is performed, the status data cannot be transmitted in real time when a change in the status of the peripheral device occurs, resulting in a time lag between when a change in the status occurs in the peripheral device and when the host device acquires the status data. This causes a problem in that the time it takes for the host device to acquire the status data of the printer and peripheral devices increases, resulting in a slower response.

### SUMMARY OF THE INVENTION

The present invention has been made to solve such a problem, and aims to make it possible, in a network configuration in which a peripheral device is connected to a host device and another peripheral device is connected to the peripheral device, to reduce the time it takes for the host device to acquire acquisition data acquired by the other peripheral device.

In order to solve the above-mentioned problem, an information processing system according to the present invention is configured such that a first peripheral device is connected through USB to a host device that executes a web application, and a second peripheral device is connected to the first peripheral device through USB, the information processing system being configured to: perform serial communication between the host device and the first peripheral device via a virtual serial port; and using, as a trigger, when the first peripheral device receives, from the second peripheral device, peripheral device acquisition data including an acquisition value acquired by the second peripheral device, transmit, from the first peripheral device to the host device via the virtual serial port, the peripheral device acquisition data received from the second peripheral device.

According to the present invention configured as described above, at the time when the first peripheral device receives peripheral device acquisition data from the second peripheral device, the first peripheral device can actively transmit the peripheral device acquisition data to the host device via the virtual serial port. Without needing to wait for polling from a web application of the host device, the first peripheral device can transfer the peripheral device acquisition data to the host device almost in real time at the time when the data is received from the second peripheral device, so that there is no time lag between receiving the peripheral device acquisition data and transmitting the same. This makes it possible to reduce the time it takes for the host device to acquire acquisition data acquired by the second peripheral device.

### BRIEF DESCRIPTION OF THE DRAWINGS

FIG. 1 is a diagram illustrating an overall configuration example of an information processing system according to a first embodiment;

FIG. 2 is a diagram illustrating a hardware configuration example of a printer;

FIG. 3 is a diagram illustrating a hardware configuration example of a BCR;

FIG. 4 is a diagram illustrating a hardware configuration example of a host device;

FIG. 5 is a block diagram illustrating a functional configuration example of the printer;

FIG. 6 is a sequence diagram illustrating an example of a processing procedure for the host device acquiring BCR data in the information processing system according to the first embodiment; and

FIG. 7 is a sequence diagram illustrating an example of a processing procedure for a host device acquiring BCR data in an information processing system according to a second embodiment.

### DETAILED DESCRIPTION

### First Embodiment

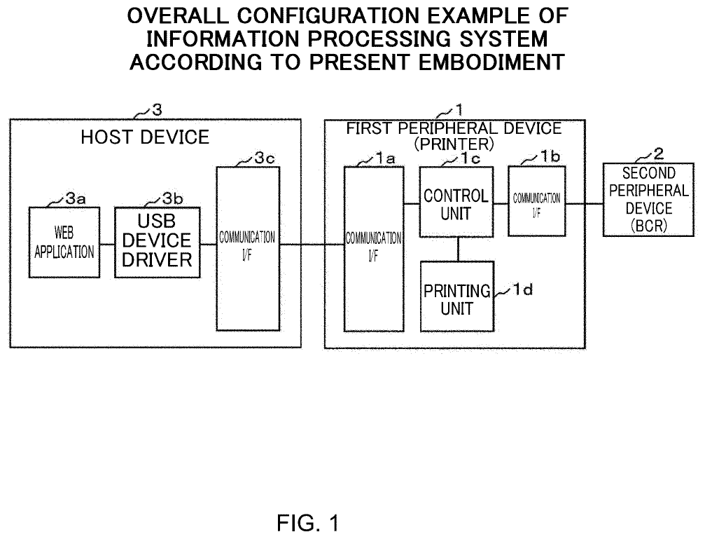

A first embodiment of the present invention will be described below on the basis of the drawings. FIG. 1 is a diagram illustrating an overall configuration example of an information processing system according to the first embodiment. As illustrated in FIG. 1, the information processing system according to the first embodiment is configured to include a host device 3, a first peripheral device 1 connected to the host device 3 through USB, and a second peripheral device 2 connected to the first peripheral device 1 through USB. In the information processing system of the present embodiment, the host device 3 acquires via the first peripheral device 1 peripheral device acquisition data including an acquisition value acquired by the second peripheral device 2.

The first peripheral device 1 and the second peripheral device 2 are devices that can be used by connecting to a general-purpose computer with a USB cable, and can be used as input devices, output devices, auxiliary storage devices, network devices, and the like. In the following, an example will be described in which a printer, which is an output device, is used as the first peripheral device 1, and a barcode reader (BCR), which is an input device, is used as the second peripheral device 2. In the following description, the first peripheral device 1 is referred to as the printer 1, and the second peripheral device 2 is referred to as the BCR 2.

The printer 1 includes a communication interface 1a configured to transmit and receive data to and from the host device 3, a communication interface 1b configured to transmit and receive data to and from the BCR 2, a control unit 1c configured to control data communication between the printer 1 and the BCR 2 and print processing, and a printing unit 1d configured to perform printing. The internal configuration of the BCR 2 is not illustrated.

The host device 3 is configured as a general-purpose computer such as a personal computer, a tablet, or a smartphone, for example. Alternatively, the host device 3 may be configured as a dedicated computer such as a POS terminal, for example. A USB device driver 3b is installed on the host device 3. A web application 3a is executed in the host device 3. The host device 3 also includes a communication interface 3c configured to transmit and receive data to and from the printer 1.

The web application 3a can transmit a print command and print data to the printer 1 via the USB device driver 3b and the communication interface 3c, thereby causing the printer 1 to perform printing based on the print data. The web application 3a can also acquire various types of status data acquired by the printer 1 and data read by the BCR 2 connected to the printer 1 (hereinafter referred to as BCR data) via the USB device driver 3b and the communication interface 3c. The BCR data corresponds to peripheral device acquisition data.

The web application 3a transmits and receives data to and from the printer 1 using, for example, Web USB API or Web Serial API. Even when the host device 3 and the printer 1 are physically connected to each other with a USB cable, the printer 1 and the host device 3 support virtual serial ports as their communication interfaces 1a and 3c, so that the web application 3a can perform serial communication with the printer 1 using the Web Serial API. In the first embodiment described below, the host device 3 performs serial communication with the printer 1 using the Web Serial API for processing of acquiring peripheral device acquisition data. If virtual serial technology is used, the communication between the host device 3 and the printer 1 can also be established through Bluetooth (registered trademark).

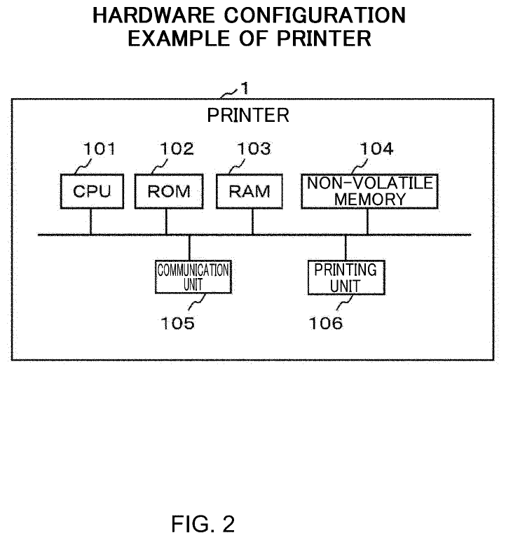

FIG. 2 is a diagram illustrating a hardware configuration example of the printer 1. As illustrated in FIG. 2, the printer 1 includes, as a hardware configuration, a CPU 101, a ROM 102, a RAM 103, a non-volatile memory 104, a communication unit 105, and a printing unit 106.

The CPU 101 controls the operation of the printer 1 in accordance with a program stored in the ROM 102 or the non-volatile memory 104 while using the RAM 103 as a work memory. The CPU 101, the ROM 102, the RAM 103, and the non-volatile memory 104 make up the control unit 1c in FIG. 1. The CPU 101 controls, for example, printing to be performed based on print data transmitted from the host device 3. The CPU 101 also performs processing related to acquiring status data of the printer 1 and BCR data from the BCR 2 and transferring such data to the host device 3.

The communication unit 105 has a function equivalent to the communication interface 1a in FIG. 1, and performs data communication with the host device 3 via a USB cable. For example, the communication unit 105 receives print data together with a print command from the host device 3, and transmits to the host device 3 status data indicating a print result. The communication unit 105 transmits to the host device 3 status data indicating that a change has occurred in the status of the printer 1. The communication unit 105 receives BCR data from the BCR 2, and transmits the received BCR data to the host device 3.

The communication unit 105 has a function equivalent to the communication interface 1b in FIG. 1, and performs data communication with the BCR 2 via a USB cable. For example, the communication unit 105 receives BCR data from the BCR 2. Specifically, the communication unit 105 performs USB communication with the BCR 2 using interrupt transfer with an interval time set to a predetermined time or less, and receives BCR data from the BCR 2 within the predetermined time at the latest from the time when the BCR 2 reads a barcode. The interrupt transfer is performed with the printer 1 as the USB host and the BCR 2 as the USB device. It is also possible to use isochronous transfer instead of the interrupt transfer.

By setting the interval time to a very short time such as a few milliseconds, the printer 1 can acquire the BCR data in real time with almost no time lag from the time when the BCR 2 reads the barcode. Since the printer 1 performs serial communication with the host device 3 as described above, the printer 1 can actively transmit the acquired BCR data to the host device 3 at the time when the BCR data is acquired from the BCR 2.

The printing unit 106 corresponds to the printing unit 1d in FIG. 1, and in response to receiving an instruction to perform printing from the CPU 101, performs print processing based on print data.

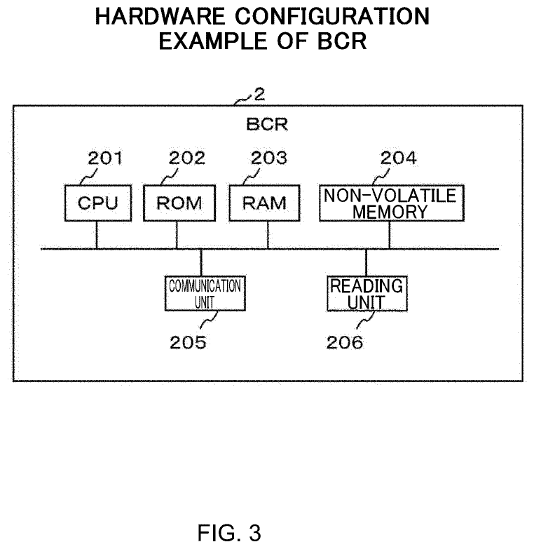

FIG. 3 is a diagram illustrating a hardware configuration example of the BCR 2. As illustrated in FIG. 3, the BCR 2 includes, as a hardware configuration, a CPU 201, a ROM 202, a RAM 203, a non-volatile memory 204, a communication unit 205, and a reading unit 206.

The CPU 201 controls the operation of the BCR 2 in accordance with a program stored in the ROM 202 or the non-volatile memory 204 while using the RAM 203 as a work memory. In response to receiving an instruction to read a barcode from the CPU 201, the reading unit 206 performs processing of reading the barcode.

The communication unit 205 performs data communication with the printer 1 via a USB cable. For example, the communication unit 205 transmits BCR data acquired in the processing of reading the barcode to the printer 1. Specifically, the communication unit 205 performs USB communication with the communication unit 105 of the printer 1 using interrupt transfer as described above. This enables the communication unit 205 to transmit the BCR data to the printer 1 almost in real time at the time when the barcode is read.

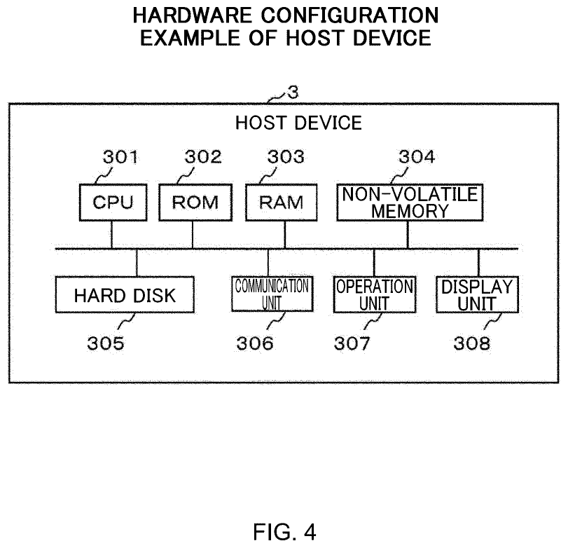

FIG. 4 is a diagram illustrating a hardware configuration example of the host device 3. As illustrated in FIG. 4, the host device 3 includes, as a hardware configuration, a CPU 301, a ROM 302, a RAM 303, a non-volatile memory 304, a hard disk 305, a communication unit 306, an operation unit 307, and a display unit 308.

The CPU 301 controls the operation of the host device 3 in accordance with a program stored in the ROM 302, the non-volatile memory 304, or the hard disk 305 while using the RAM 303 as a working memory. The hard disk 305 stores various types of programs and data.

The communication unit 306 has a function equivalent to the communication interface 3c in FIG. 1, and performs data communication with the printer 1 via a USB cable. For example, the communication unit 306 transmits print data together with a print command to the printer 1, and receives from the printer 1 status data indicating a print result. The communication unit 306 receives from the printer 1 status data acquired by the printer 1 and BCR data transmitted from the BCR 2 to the printer 1.

With regard to the processing of receiving the BCR data from the printer 1, the communication unit 306 performs serial communication with the printer 1 using the Web Serial API started by the web application 3a, as described above. On the other hand, data communication related to the print processing to be performed between the host device 3 and the printer 1 is performed using the Web USB API. Processing for the web application 3a to acquire status data from the printer 1 may be performed using the Web Serial API or the Web USB API.

The operation unit 307 allows the user to perform various types of operations including operations related to generation of print data and an instruction for printing, and operations related to instructions to acquire status data of the printer 1 and BCR data, and is made up of a keyboard and mouse, a touch panel, or the like. The display unit 308 is for displaying data such as images and text generated by the web application 3a, status data acquired from the printer 1, and data related to an acquisition value acquired by the BCR 2, and is made up of, for example, an LCD display, an organic EL display, or the like.

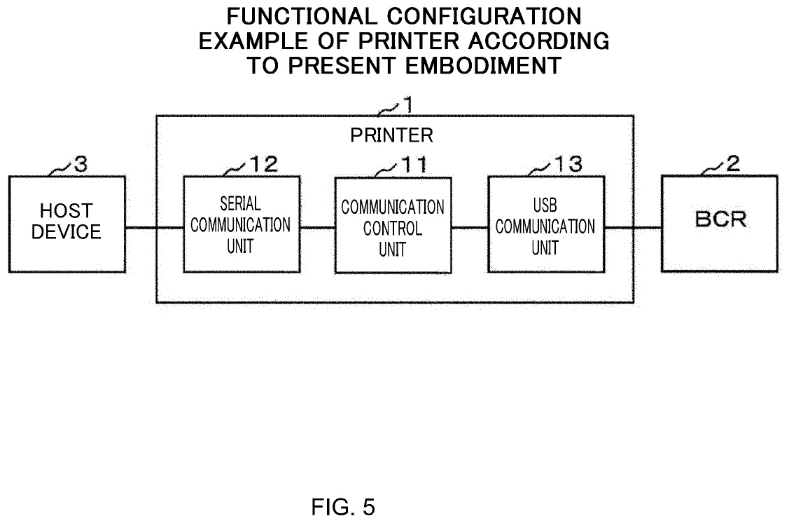

FIG. 5 is a block diagram illustrating a functional configuration example of the printer 1. Here, the functional configuration related to printing is not illustrated, and only the functional configuration related to acquiring BCR data, which is the subject of the present embodiment, is illustrated. As illustrated in FIG. 5, the printer 1 according to the first embodiment includes, as a functional configuration, a communication control unit 11, a serial communication unit 12, and a USB communication unit 13.

The functional blocks 11 to 13 performs processing described below through cooperation between hardware and software. For example, the processing of the communication control unit 11 is performed by a program stored in the ROM 102 or the non-volatile memory 104 operating, under the control of a processor of a microcomputer configured to include the CPU 101, the ROM 102, the RAM 103, and others, which are illustrated in FIG. 2. The processing of the serial communication unit 12 and the USB communication unit 13 are performed by the communication unit 105 (the communication interfaces 1a and 1b in FIG. 1) operating, under the control of the communication control unit 11.

The serial communication unit 12 performs serial communication with the host device 3 via a virtual serial port. The serial communication unit 12 transmits the BCR data acquired from the BCR 2 to the web application 3a of the host device 3 via the virtual serial port, under the control of the communication control unit 11.

The USB communication unit 13 performs USB communication with the BCR 2 using interrupt transfer with the interval time set to a predetermined time or less, under the control of the communication control unit 11. The USB communication unit 13 serves as a USB host to repeatedly transmit an IN token to the BCR 2 at short interval times. Upon receiving the IN token, if there is BCR data at that time, the BCR 2 responds with the BCR data; if there is no BCR data, the BCR 2 responds that there is no data. Thus, the BCR 2 responds to the USB communication unit 13 of the printer 1 with the BCR data within a predetermined time at the latest from the time when the BCR data is acquired by performing the processing of reading a barcode.

The communication control unit 11 performs control so that, using the event of receiving the BCR data transmitted from the BCR 2 as a trigger, the BCR data received from the BCR 2 is transmitted to the web application 3a of the host device 3. In other words, when the communication control unit 11 detects that the USB communication unit 13 performing the interrupt transfer has received the BCR data from the BCR 2, the communication control unit 11 controls the serial communication unit 12 to transmit the BCR data to the web application 3a of the host device 3. When the communication control unit 11 receives from the BCR 2 data indicating that there is no BCR data, the communication control unit 11 does not transmit that data to the web application 3a.

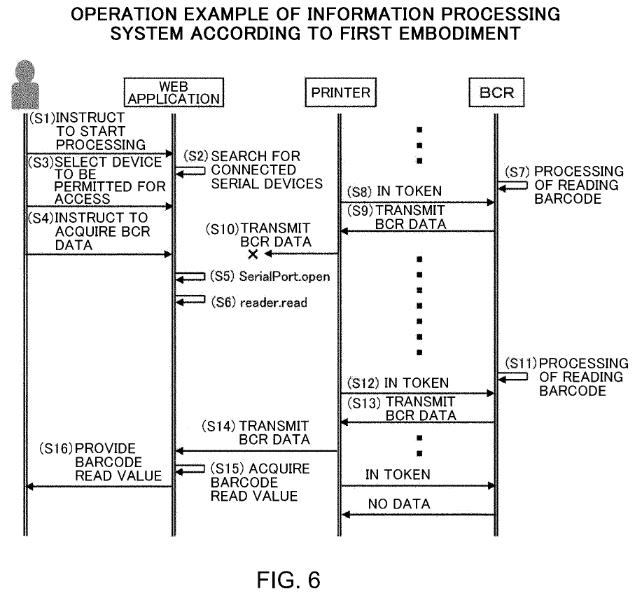

FIG. 6 is a sequence diagram illustrating an example of a processing procedure for the host device 3 to acquire BCR data in the information processing system according to the first embodiment.

First, for example, the user presses a connection button on the web application 3a to instruct the start of a series of processing (step S1). In response to this instruction, the web application 3a searches for serial devices already connected to the host device 3, and presents the result as list information on a screen of the display unit 308 (step S2). This list information includes information about the printer 1 that supports the virtual serial port.

Now, the user selects one of the serial devices from the list, thereby granting permission to access the selected serial device to the web application 3a (step S3). In this example, it is assumed that the user has selected a printer 1. Thus, the web application 3a acquires the printer 1 as a serial port object that is communicable with the web application 3a.

Next, the user instructs to acquire BCR data by, for example, pressing a read button for BCR data on the web application 3a (step S4). In response to this instruction, the web application 3a performs the open method for the SerialPort interface of the Web Serial API to open a virtual serial port (step S5). This enables the web application 3a to communicate with the printer 1 that supports the virtual serial port. Then, the web application 3a performs the read method for the Reader instance reader acquired from the SerialPort interface of the Web Serial API (hereinafter referred to as the reader. read method) to wait for data reception from the printer 1 (step S6).

In parallel with the above-described processing by the web application 3a, a USB communication using interrupt transfer is constantly performed between the printer 1 and the BCR 2. As described above, the printer 1 serves as a USB host to repeatedly transmit an IN token to the BCR 2 at short interval times. Upon receiving the IN token, if there is BCR data at that time, the BCR 2 responds with the BCR data; if there is no BCR data, the BCR 2 responds that there is no data.

For example, when the BCR 2 performs the processing of reading a barcode at a timing before the web application 3a performs the Reader. read method in step S6 (step S7), and then receives an IN token transmitted from the printer 1 immediately after acquiring BCR data by the processing of reading (step S8), the BCR 2 responds with the BCR data to the printer 1 (step S9). In response to this, using the event of receiving the BCR data as a trigger, the printer 1 transmits the BCR data to the web application 3a (step S10). However, at this stage, the web application 3a is not yet in a state of waiting for data, and therefore cannot receive the BCR data.

On the other hand, when the BCR 2 performs the processing of reading a barcode at a timing after the web application 3a performs the Reader. read method in step S6 (step S11), and then receives an IN token transmitted from the printer 1 immediately thereafter (step S12), the BCR 2 responds with the BCR data to the printer 1 (step S13). In response to this, using the event of receiving the BCR data as a trigger, the printer 1 transmits the BCR data to the web application 3a (step S14). At this stage, the web application 3a is in a state of waiting for data, and is therefore can receive the BCR data.

When receiving the BCR data from the printer 1, the web application 3a processes the BCR data to acquire a read value of the barcode (step S15), and provides the read value to the user (step S16). Providing the read value to the user is performed by displaying the read value on the display unit 308, for example.

As described in detail above, an information processing system according to the first embodiment is configured such that a first peripheral device 1 is connected through USB to a host device 3 that executes a web application 3a, a second peripheral device 2 is connected to the first peripheral device 1 through USB, and the host device 3 acquires, via the first peripheral device 1, acquisition data acquired by the second peripheral device 2, the information processing system being configured to: perform serial communication between the web application 3a of the host device 3 and the first peripheral device 1 via a virtual serial port; and using, as a trigger, when the first peripheral device 1 receives peripheral device acquisition data from the second peripheral device 2, transmit, from the first peripheral device 1 to the web application 3a of the host device 3 via the virtual serial port, the peripheral device acquisition data received from the second peripheral device 2.

According to the first embodiment configured as above, at the time when the first peripheral device 1 receives peripheral device acquisition data from the second peripheral device 2, the first peripheral device 1 can actively transmit the peripheral device acquisition data to the web application 3a via the virtual serial port. Without needing to wait for polling from the web application 3a, the first peripheral device 1 can transfer the peripheral device acquisition data to the web application 3a almost in real time at the time when the data is received from the second peripheral device 2, so that there is no time lag between receiving the peripheral device acquisition data from the second peripheral device 2 and transmitting the same to the web application 3a. This makes it possible to reduce the time it takes for the host device 3 to acquire the acquisition data acquired by the second peripheral device 2.

In the first embodiment, the second peripheral device 2 is configured to perform USB communication with the first peripheral device 1 using interrupt transfer with an interval time set to a value shorter than a predetermined time, and transmit the peripheral device acquisition data to the first peripheral device 1 within a predetermined time at the latest from the time when the peripheral device acquisition data is acquired. As a result, there is almost no time lag between the time when the second peripheral device 2 acquires the peripheral device acquisition data and when the second peripheral device 2 transmits the data to the first peripheral device 1. This makes it possible to shorten the time it takes from when the second peripheral device 2 acquires the peripheral device acquisition data to when the host device 3 acquires the peripheral device acquisition data.

### Second Embodiment

Next, a second embodiment of the present invention will be described on the basis of the drawings. The overall configuration of an information processing system according to the second embodiment is the same as that illustrated in FIG. 1. The hardware configurations of a first peripheral device 1 (printer 1), a second peripheral device 2 (BCR 2), and a host device 3 are the same as those illustrated in FIGS. 2 to 4. The functional configuration of the printer 1 is the same as that illustrated in FIG. 5. In the second embodiment, the processing performed by the web application 3a in the host device 3 is different from that in the first embodiment.

In the second embodiment, the web application 3a starts a sub-thread from a main thread, performs serial communication with the first peripheral device 1 by the sub-thread, and passes, from the sub-thread to the main thread, the peripheral device acquisition data received from the first peripheral device 1. Starting the sub-thread can be achieved, for example, using the mechanism of Web Workers. Web Workers provide a mechanism for transferring script processing in the web application 3a to a thread separate from the main thread, enabling it to be executed in the background.

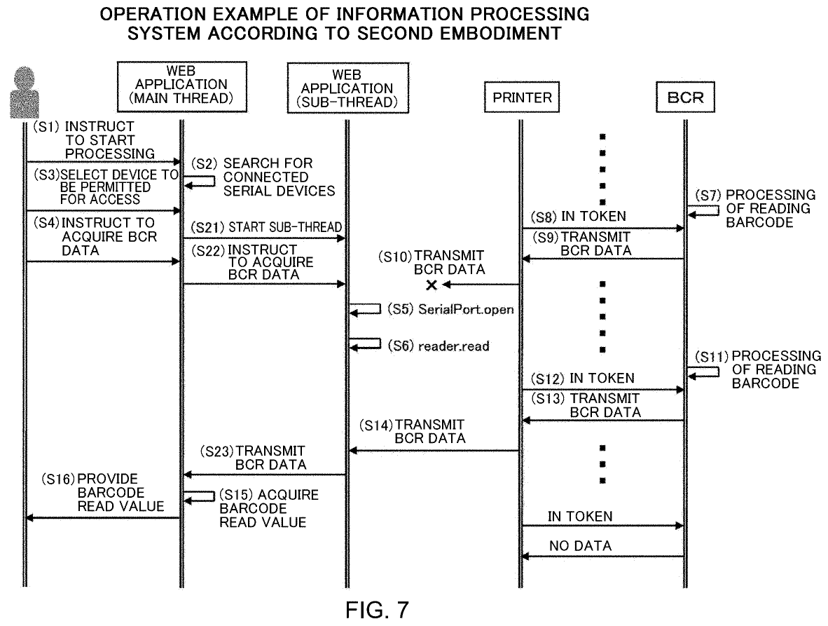

FIG. 7 is a sequence diagram illustrating an example of a processing procedure for the web application 3a of the host device 3 to acquire BCR data in the information processing system according to the second embodiment. In FIG. 7, the processing of the same step number as that illustrated in FIG. 6 has the same content, and therefore, duplicated description will be omitted below.

In the second embodiment, the processing of steps S1 to S4 and steps S15 and S16 are performed by the main thread of the web application 3a. The main thread mainly performs processing related to interactions with the user. On the other hand, the processing of steps S5, S6, and S14 are performed by the sub-thread of the web application 3a. The sub-thread mainly performs processing related to communication with the printer 1. Although Web Worker threads have some limitations, such as the inability to directly operate the UI of the web application 3a, they are communicable with the printer 1.

In step S3, when the user selects the printer 1 from the list to grant permission to access the printer 1 to the main thread of the web application 3a, the web application 3a starts the sub-thread from the main thread using Web Workers (step S21). After that, when the user instructs the main thread of the web application 3a to acquire BCR data (step S4), the web application 3a instructs the sub-thread from the main thread to acquire BCR data (step S22). In response to this instruction, the sub-thread of the web application 3a opens a virtual serial port (step S5).

After that, when the BCR 2 performs the processing of reading a barcode (step S11), and then responds with the BCR data to the printer 1 in response to the IN token transmitted from the printer 1 (steps S12, S13), the printer 1 transmits the BCR data acquired from the BCR 2 to the sub-thread of the web application 3a (step S14).

When receiving the BCR data from the printer 1, the web application 3a passes the BCR data from the sub-thread to the main thread (step S23). The main thread processes the BCR data passed from the sub-thread to acquire a read value of the barcode (step S15), and provides the read value to the user (step S16).

As described in detail above, in the second embodiment, the sub-thread is started from the main thread of the web application 3a, serial communication is performed with the printer 1 by the sub-thread, and the BCR data received from the printer 1 is passed from the sub-thread to the main thread.

According to the second embodiment configured as above, data communication between the web application 3a and the printer 1 is left to the sub-thread, so that the amount of processing performed by the main thread of the web application 3a can be reduced. This makes it possible to suppress a slow response in processing related to user interaction performed by the main thread, and to minimize the adverse effects on UI processing.

In the above-described first and second embodiments, an example has been described in which the BCR 2 is used as the second peripheral device 2 to be connected to the printer 1. However, the related configuration is not limited to this. For example, instead of or in addition to the BCR 2, an output device such as a customer display, and an input device such as a scale, a card reader, and a keyboard may be used as devices to be connected. One or more USB devices may be connected to the printer 1. In this case, instead of or in addition to the read data of the BCR 2, measurement data and input data of the input device, and status data of the input device or the output device may be used as peripheral device acquisition data. Depending on the type of the second peripheral device 2, the USB communication with the printer 1 may be performed using bulk transfer instead of interrupt transfer or isochronous transfer.

In the above-described first and second embodiments, an example has been described in which the printer 1 is used as the first peripheral device 1. However, the related configuration is not limited to this. For example, instead of the printer 1, an output device such as a customer display, and an input device such as a BCR, a scale, a card reader, and a keyboard may be connected between the host device 3 and the second peripheral device 2.

In addition, all of the embodiments described above merely illustrate specific examples of implementation of the present invention, and the technical scope of the present invention is not to be interpreted as being limited thereby. In other words, the present invention can be implemented in various forms without deviating from the spirit or the main features thereof.

What is claimed is:

1. An information processing system in which a first peripheral device is connected through USB to a host device that executes a web application, a second peripheral device is connected to the first peripheral device through USB, and the host device acquires, via the first peripheral device, peripheral device acquisition data including an acquisition value acquired by the second peripheral device,
the first peripheral device being configured to: perform serial communication with the host device via a virtual serial port; and using an event of receiving the peripheral device acquisition data transmitted from the second peripheral device as a trigger, transmit the peripheral device acquisition data received from the second peripheral device to the host device.

2. The information processing system according to claim 1, wherein the second peripheral device is configured to: perform USB communication with the first peripheral device using interrupt transfer, isochronous transfer, or bulk transfer with an interval time set to a predetermined time or less; and transmit the peripheral device acquisition data to the first peripheral device within the predetermined time at the latest from the time when the peripheral device acquisition data is acquired.

3. The information processing system according to claim 1, wherein the host device is configured to: start a sub-thread from a main thread; perform the serial communication with the first peripheral device by the sub-thread; and pass, from the sub-thread to the main thread, the peripheral device acquisition data received from the first peripheral device.

4. The information processing system according to claim 2, wherein the host device is configured to: start a sub-thread from a main thread; perform the serial communication with the first peripheral device by the sub-thread; and pass, from the sub-thread to the main thread, the peripheral device acquisition data received from the first peripheral device.

5. A peripheral device that is connected to a host device that executes a web application through USB, is connected to a second peripheral device through USB, and is configured to provide, to the host device, peripheral device acquisition data including an acquisition value acquired by the second peripheral device,
the peripheral device being configured to: perform serial communication with the host device via a virtual serial port; and using an event of receiving the peripheral device acquisition data transmitted from the second peripheral device as a trigger, transmit the peripheral device acquisition data received from the second peripheral device to the host device.

6. An information processing method that, in a system in which a first peripheral device is connected to a host device that executes a web application through USB and a second peripheral device is connected to the first peripheral device through USB, provides, to the host device via the first peripheral device, peripheral device acquisition data including an acquisition value acquired by the second peripheral device, the information processing method comprising the steps of:
opening, by the host device, a virtual serial port;
transmitting, by the second peripheral device, the peripheral device acquisition data to the first peripheral device; and
using an event of receiving the peripheral device acquisition data transmitted from the second peripheral device as a trigger, transmitting, by the first peripheral device, the peripheral device acquisition data received from the second peripheral device to the host device via the virtual serial port.
